(19) United States
(12) Patent Application Publication
(10) Pub. No.: US 2022/0321544 A1
(43) Pub. Date: Oct. 6, 2022

(54) GAS METER READING SYSTEM BASED ON NATIONAL CRYPTOGRAPHIC ALGORITHM AND GAS DATA TRANSMISSION METHOD THEREOF

(71) Applicants: SHENZHEN GAS CORPORATION LTD., Shenzhen, Guangdong (CN); SHENZHEN GAS TECHNOLOGY RESEARCH INSTITUTE, Shenzhen, Guangdong (CN)

(72) Inventors: Chengming AN, Shenzhen (CN); Guang YANG, Shenzhen (CN); Wei MENG, Shenzhen (CN); Chao XU, Shenzhen (CN)

(73) Assignees: SHENZHEN GAS CORPORATION LTD., Shenzhen, Guangdong (CN); SHENZHEN GAS TECHNOLOGY RESEARCH INSTITUTE, Shenzhen, Guangdong (CN)

(21) Appl. No.: 17/614,441

(22) PCT Filed: May 8, 2021
(86) PCT No.: PCT/CN2021/092467

§ 371 Date: Nov. 26, 2021

(30) Foreign Application Priority Data
Jul. 17, 2020 (CN) 202010693687.7

(51) Int. Cl. H04L 9/40; H04Q 9/00; H04L 9/06; H04L 9/08

(52) U.S. Cl. CPC H04L 63/0435; H04Q 9/00; H04L 9/0618; H04L 9/0819; H04Q 2209/60

(57) ABSTRACT

A gas meter reading system based on national cryptographic algorithm and gas data transmission method thereof. The system includes: an information acquisition device, central information processor, national cryptographic algorithm module, receiving terminal. The method includes: collecting gas data; generating meter reading data; encrypting meter reading data; generating first ciphertext; encrypting first abstract of first ciphertext; generating first abstract ciphertext; sending first ciphertext and first abstract ciphertext to receiving terminal; decrypting first abstract ciphertext to obtain first abstract, recalculating abstract of first ciphertext to obtain second abstract, decrypting first ciphertext to obtain meter reading data after second abstract matches with first abstract. Through dual encryption mode of encrypting and transmitting meter reading data and first abstract of first ciphertext, meter reading data is obtained only after dual encryption verification succeeds, so data transmission security is improved, stealing is prevented.

### FIELD OF THE INVENTION

The present disclosure relates to the technical field of gas data processing, and more particularly, to a gas meter reading system based on a national cryptographic algorithm and a gas data transmission method thereof.

### BACKGROUND

Gases distributed by a gas supply industry mainly comprise three kinds: coal gas, liquefied petroleum gas and natural gas. Gas supply in our country has increased substantially since the 1990s. Wherein, after a substantial increase in a supply of artificial gas in 1990, due to a plurality of shortcomings thereof including a relatively great pollution and a relatively strong toxicity, the artificial gas is now in a relatively slow growth stage; the liquefied petroleum gas, affected by an increase in an oil price, is having a supply remaining stable. Compared with gasoline and diesel, a price of the natural gas generating a same calorific value is 30%-50% cheaper, having an obvious economic efficiency. At a same time, our country is paying more and more attention to an environmental protection, making a market demand for clean energy continue growing. As a clean, efficient and cheap energy, a natural gas consumption has achieved a rapid development.

When a resident is using a gas, a gas company needs to read a meter of the gas. However, in a process of an information transmission, a traditional meter reading system transmits the information directly without an encryption and a verification, which is very easy to be stolen, bringing a hidden danger of both personal privacy information security and economic security.

Therefore, the current technology needs to be improved and developed.

### BRIEF SUMMARY OF THE DISCLOSURE

According to the defects in the prior art described above that an information transmission has a low security, it is necessary to provide a gas meter reading system based on a national cryptographic algorithm and a gas data transmission method thereof.

In order to achieve the above mentioned goals, the technical solution of the present disclosure to solve the technical problems is as follows:

A gas meter reading system based on a national cryptographic algorithm, wherein comprising: an information acquisition device, a sending terminal, and a receiving terminal connecting in a sequence, the sending terminal has a central information processor and a national cryptographic algorithm module connected to the central information processor, wherein the central information processor is applied to receiving and processing a gas data to generate a meter reading data; the national cryptographic algorithm module is applied to encrypting the meter reading data to generate a first ciphertext, and encrypting a first digest of the first ciphertext to generate a first digest ciphertext, before sending the first ciphertext and the first digest ciphertext to the receiving terminal;

the receiving terminal is applied to decrypting the first digest ciphertext to obtain the first digest, and recalculating a digest of the first ciphertext to obtain a second digest, after matching the second digest with the first digest successfully, decrypting the first ciphertext to obtain the meter reading data.

The gas meter reading system, wherein further comprising:

a gas concentration detector, connecting to the information acquisition device, applied to detecting a gas concentration when the gas meter reading system is in use, so that the central information processor is able to determine a gas concentration level corresponding to the gas concentration, according to the gas concentration;

a temperature detector, connecting to the information acquisition device and applied to detecting a temperature when the gas meter reading system is in use, so that the central information processor is able to determine a temperature level corresponding to the temperature according to the temperature.

The gas meter reading system, wherein further comprising:

a controller, an input terminal of the controller connecting to the central information processor, and an output terminal of the controller connecting to a buzzer, applied to receiving a warning signal from the central information processor before controlling the buzzer to ring according to the warning signal.

The gas meter reading system, wherein further comprising:

a display module, connecting to the central information processor and applied to displaying a data; comprising an LCD display and a display driver interface, while the display driver interface is arranged on the LCD display.

The gas meter reading system, wherein further comprising:

a wireless receiving module, connecting to the receiving terminal, being a super regenerative receiving circuit, and having an antenna arranged.

The present disclosure further provides a gas data transmission method based on the national cryptographic algorithm, comprising:

an information acquisition device collects the gas data;

the central information processor of the sending terminal receives and processes the gas data before generating the meter reading data;

the national cryptographic algorithm module of the sending terminal encrypts the meter reading data to generate the first ciphertext, and encrypts the first digest of the first ciphertext to generate a first digest ciphertext, before sending both the first ciphertext and the first digest ciphertext to the receiving terminal;

the receiving terminal decrypts the first digest ciphertext to obtain the first digest, and recalculates a digest of the first ciphertext to obtain a second digest, after ensuring that the second digest matches with the first digest successfully, decrypts the first ciphertext to obtain the meter reading data.

The gas data transmission method, wherein further comprising:

when it is ensured that the second digest does not match with the first digest, the receiving terminal feeds back a message of verification failure, and discards the first ciphertext.

The gas data transmission method, wherein before the information acquisition device collecting the gas data, comprising:

the national cryptographic algorithm module and the receiving terminal negotiate in advance to adopt a same SM1 symmetric encryption mode for a transmission, and set a common first symmetric key.

The gas data transmission method, wherein the meter reading data comprises a gas usage amount data, the national cryptographic algorithm module of the sending terminal encrypts the meter reading data to generate the first ciphertext, and encrypts the first digest of the first ciphertext to generate the first digest ciphertext, before sending both the first ciphertext and the first digest ciphertext to the receiving terminal, comprising:

the national cryptographic algorithm module acquires the gas usage amount data;

the national cryptographic algorithm module uses the first symmetric key to perform an SM1 encryption onto the gas usage amount data, before obtaining the first ciphertext;

the national cryptographic algorithm module adopts an SM3 digest algorithm to perform a digest calculation on the first ciphertext, before obtaining the first digest;

the national cryptographic algorithm module performs an inversion operation on the first symmetric key, to obtain a second symmetric key;

the national cryptographic algorithm module uses the second symmetric key to perform an SM1 encryption onto the first digest before obtaining the first digest ciphertext;

the national encryption algorithm module sends both the first ciphertext and the first digest ciphertext to the receiving terminal.

The gas data transmission method, wherein the receiving terminal decrypts the first digest ciphertext to obtain the first digest, and recalculating the digest of the first ciphertext to obtain the second digest, and after ensuring that the second digest is matched with the first digest successfully, decrypting the first ciphertext to obtain the meter reading data, comprising:

the receiving terminal receives the first ciphertext and the first digest ciphertext;

the receiving terminal performs an inversion operation on the first symmetric key, before obtaining the second symmetric key;

the receiving terminal uses the second symmetric key to decrypt the first digest ciphertext to obtain the first digest;

the receiving terminal recalculates the digest of the first ciphertext before obtaining the second digest;

when the second digest is as same as the first digest, using the first symmetric key to decrypt the first ciphertext, before obtaining the meter reading data, wherein the meter reading data comprises the gas usage amount data.

Benefits: comparing to the prior art, the present disclosure provides a gas meter reading system based on a national cryptographic algorithm and a gas data transmission method thereof, the gas meter reading system based on the national cryptographic algorithm comprises an information acquisition device, a sending terminal, and a receiving terminal connecting in a sequence, the sending terminal has a central information processor and a national cryptographic algorithm module connected to the central information processor, wherein the central information processor is applied to receiving and processing the gas data to generate a meter reading data; the national cryptographic algorithm module is applied to encrypting the meter reading data to generate a first ciphertext, and encrypting a first digest of the first ciphertext to generate a first digest ciphertext, before sending the first ciphertext and the first digest ciphertext to the receiving terminal; the receiving terminal is applied to decrypting the first digest ciphertext to obtain the first digest, and recalculating a digest of the first ciphertext to obtain a second digest, after matching the second digest with the first digest successfully, decrypting the first ciphertext to obtain the meter reading data. Through a mode of a dual encryption that encrypts and transmits the meter reading data as well as encrypts and transmits the first digest of the first ciphertext, the meter reading data can be obtained only after a verification success of the dual encryption, so that a data transmission security is greatly improved, and a stealing is prevented.

### BRIEF DESCRIPTION OF THE DRAWINGS

FIG. 1 illustrates a structural block diagram on a gas meter reading system based on a national cryptographic algorithm provided by the present disclosure.

FIG. 2 illustrates a flow chart on a gas data transmission method based on a national cryptographic algorithm provided by the present disclosure.

### DETAILED DESCRIPTION OF EMBODIMENTS

In order to make the purpose, technical solution and the advantages of the present disclosure clearer and more explicit, further detailed descriptions of the present disclosure are stated here, referencing to the attached drawings and some embodiments of the present disclosure. It should be understood that the detailed embodiments of the disclosure described here are used to explain the present disclosure only, instead of limiting the present disclosure.

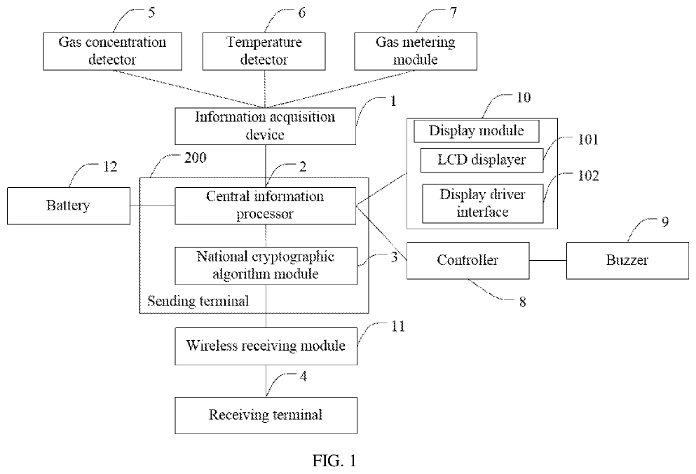

Referencing to FIG. 1, which illustrates a structural block diagram on a gas meter reading system based on a national cryptographic algorithm provided by the present disclosure. Shown as FIG. 1, the gas meter reading system based on the national cryptographic algorithm comprises an information acquisition device 1, a central information processor 2 in a sending terminal 200, a national cryptographic algorithm module 3, a receiving terminal 4, a gas concentration detector 5, a temperature detector 6, a gas metering module 7, a controller 8, a buzzer 9, a display module 10, a wireless receiving module 11, a battery 12. Wherein, the information acquisition device 1, an input terminal of the national cryptographic algorithm module 3, an input terminal of the controller 8, the display module 10 and the battery 12 are all connected to the central information processor 2. The buzzer 9 connects to an output terminal of the controller 8. The receiving terminal 4 and the national cryptographic algorithm module 3 have the wireless receiving module 11 arranged in between. The national cryptographic algorithm module 3, the wireless receiving module 11 and the receiving terminal 4 are connected in a sequence. The wireless receiving module 11 has an antenna (not shown in the figures) arranged for receiving a communication data.

Specifically, the information acquisition device 1 is applied to collecting a gas data, and the gas data comprises a gas usage amount data, a gas concentration value, a temperature value and more. In the present embodiment, the information acquisition device 1 has a gas metering module 7 connected, the gas metering module 7 may be a flow meter, and the flow meter comprises one or more of a natural gas meter, a liquefied gas meter, and a gas meter.

The central information processor 2 is applied to receiving and processing the gas data to generate a meter reading data. When the gas data comprises a gas concentration, the central information processor 2 determines a gas concentration level corresponding to the gas concentration according to the gas concentration. Dividing the gas concentration into three levels: high, medium, and low, and setting a gas concentration interval corresponding to each gas concentration level, as well as a gas concentration warning threshold. When the gas concentration level is high or the gas concentration is greater than or equal to the gas concentration warning threshold, the central information processor 2 may send a concentration warning signal to the controller 8, so that the controller 8 may control the buzzer 9 to ring and give out an alarm according to the concentration warning signal.

If the gas data comprises a temperature, the central information processor 2 determines a temperature level corresponding to the temperature according to the temperature. Dividing the temperature into three levels: high, medium, and low, and setting a temperature interval corresponding to each temperature level, as well as a temperature warning threshold. When the temperature level is high or the temperature is greater than or equal to the temperature warning threshold, the central information processor 2 will send a temperature warning signal to the controller 8, so that the controller 8 will control the buzzer 9 to give out an alarm according to the temperature warning signal.

The embodiment of the present disclosure, wherein the central information processor 2 adopts an MCS51 series single-chip microcomputer.

The national cryptographic algorithm module 3 has a national cryptographic security chip arranged, and the national cryptographic security chip has a plurality of national cryptographic algorithms stored. The national cryptographic algorithms comprises an SM1 symmetric encryption algorithm, an SM2 asymmetric encryption algorithm, an SM3 digest algorithm, an SM4 symmetric encryption algorithm, an SM7 symmetric encryption algorithm, an SM9 asymmetric encryption algorithm, a ZUC encryption algorithm, and more. Wherein, when calling the SM1 symmetric encryption algorithm, it shall be called through an interface of the national cryptographic security chip. An SM1 algorithm is a block cipher algorithm having a packet length of 128 bits and a key length of 128 bits. A plurality of security products have been developed, including a smart IC card, a smart cryptographic key, an encryption card, an encryption machine and more, having been widely used in a plurality of application fields in national economy, including e-government, e-business and more (a plurality of important fields including national government affairs and police affairs). An SM2 algorithm is an ECC elliptic curve cryptographic mechanism. An SM2 standard comprises four parts: a general rule, a digital signature algorithm, a key exchange protocol, and a public key encryption algorithm. Each part has explained an implementation detail and an embodiment in details in an appendix thereof. An SM3 cryptographic hash algorithm gives a calculation method and a plurality of calculation steps of a hash function algorithm, as well as an embodiment on a calculation. The present algorithm is suitable for a commercial cryptographic application, including a digital signature and verification, a generation and verification of a message authentication code, and a generation of a random number, being able to meet a security requirement of various cryptographic applications. An SM4 symmetric algorithm is a block cipher algorithm, applied to a plurality of wireless local area network (WLAN) products. A packet length of the present algorithm is 128 bits, and a key length is 128 bits. Both an encryption algorithm and a key expansion algorithm adopt 32 rounds of a non-linear iterative structure. A decryption algorithm has a same structure as the encryption algorithm, except that a usage order of the round key is reversed, and the decryption round key is a reverse order of the encryption round key. In the present embodiment of the disclosure, the SM1 symmetric encryption algorithm and the SM3 digest algorithm are adopted.

The gas concentration detector 5 is applied to detecting a gas concentration when the gas meter reading system is in use. The gas concentration detector 5 comprises a fixed gas concentration detector and a portable gas concentration detector. The gas concentration detector 5 has a gas sensor arranged. The gas sensor comprises a gas sensor using a plurality of physical and chemical properties, including a semiconductor type (a surface control type, a volume control type, a surface potential type), a catalytic combustion type, a solid thermal conductivity type, and more; a gas sensor that uses a plurality of physical properties, including a heat conduction type, an optical interference type, an infrared absorption type, and more; a gas sensor that uses a plurality of electrochemical properties, including a constant-potential electrolysis type, a Gavari battery type, a diaphragm ion electrode type, a fixed electrolyte type, and more. In the present embodiment of the disclosure, the gas concentration detector 5 adopts a gas concentration detector of a model EX-TECPM300.

The temperature detector 6 is applied to detecting a temperature when the gas meter reading system is in use, so that the central information processor 2 determines the temperature level corresponding to the temperature according to the temperature. In a plurality of embodiments, the temperature detector 6 is a temperature sensor.

The controller 8 is applied to receiving a warning signal from the central information processor 2 and controlling the buzzer 9 to ring according to the warning signal. The warning signal comprises a concentration warning signal, a temperature warning signal, a humidity warning signal, a warning signal for an excess gas usage, and more.

The buzzer 9 is an electronic buzzer having an integrated structure, powered by a DC voltage, and is widely applied to a plurality of electronic products as a sounding device, including a computer, a printer, a copier, an alarm, an electronic toy, an automotive electronic equipment, a telephone, a timer and more; the buzzer 9 comprises a piezoelectric buzzer and an electromagnetic buzzer, the buzzer 9 is represented by a letter “H” or “HA” in a circuit. In the present embodiment, the buzzer 9 adopts a buzzer 9 of a model BOS0020.

The display module 10 is applied to displaying a data. The display module 10 comprises an LCD display 101 and a display driver interface 102, while the display driver interface 102 connects to the LCD display 101. The display driver interface 102 has a plurality of different types of interfaces including 4-bit, 8-bit, VGA, and more.

The wireless receiving module 11 is applied for a data communication through an antenna. In the present embodiment, a working voltage of the wireless receiving module 11 is 5 volts, a quiescent current is 4 milliamperes, the wireless receiving module 11 is a super-regenerative receiving circuit, having a receiving sensitivity of −105 dbm, and the antenna arranged is a 25˜30 cm wire. In a plurality of embodiments, the wireless receiving module 11 may be a Bluetooth module, a WiFi module, and more.

The battery 12 is applied to supply an electric energy for the gas meter reading system based on the national cryptographic algorithm.

In such a way, after a power (battery 12) is connected, when a status of the gas in the system is in use, the information acquisition device 1 obtains a gas concentration value, a temperature value and a gas usage amount, by the gas concentration detector 5, the temperature detector 6, and the gas metering module 7 detecting the gas concentration, the temperature, and by a statistics of the gas usage amount, before sending the gas concentration value, the temperature value and the gas usage amount to the central information processor 2 for an analysis and processing. If the gas concentration obtained by the analysis is greater than or equal to a gas concentration threshold, or a temperature is greater than or equal to a temperature threshold, a concentration warning signal or a temperature warning signal will be sent to the controller 8, so that the controller 8 will control the buzzer 9 to ring after receiving the concentration warning signal or the temperature warning signal, and people will deal with it in time after hearing the warning alarm. The central information processor 2 receives and processes a data of the gas usage amount to obtain a meter reading data, wherein the meter reading data comprises the gas usage amount, a remaining usage amount, a meter reading time, a fee payable, an arrear, and more, before sending the meter reading data to the national cryptographic algorithm module 3 for an encryption, then a encrypted meter reading data will be sent to a receiving terminal 4 after being encrypted by the national cryptographic algorithm module 3, so that the receiving terminal 4 will obtain the meter reading data after a decryption.

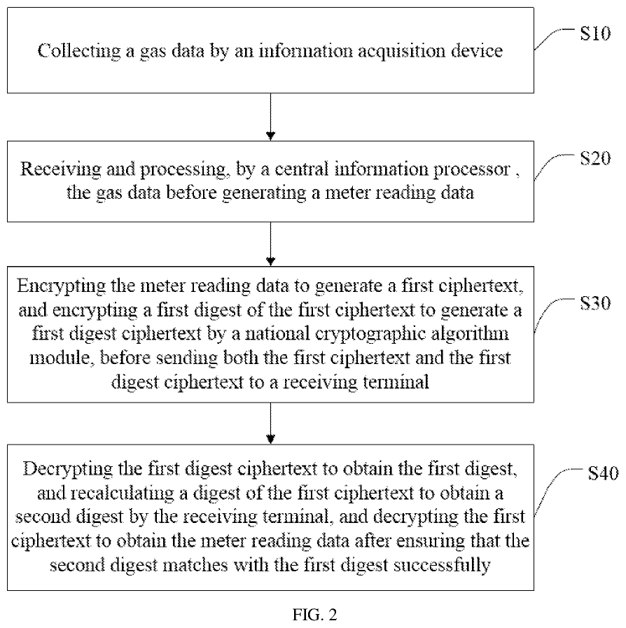

According to the gas meter reading system based on the national cryptographic algorithm, a gas data transmission method based on the national cryptographic algorithm is provided. Referencing to FIG. 2, which illustrates a flow chart on the gas data transmission method based on the national cryptographic algorithm provided by the present disclosure. It should be noted that, the gas data transmission method, based on the national cryptographic algorithm in the embodiment of the present disclosure, is not limited to the steps and sequences in the flowchart shown in FIG. 2. According to different requirements, the steps in the flowchart may be added, removed or changed in sequences.

Shown as FIG. 2, the gas data transmission method based on the national cryptographic algorithm comprises a plurality of following steps:

S10, collecting a gas data by an information acquisition device.

In the embodiment of the present disclosure, before the step S10, the national cryptographic algorithm module 3 and the receiving terminal 4 negotiate in advance to use a same SM1 symmetric encryption mode for a transmission, and set a common first symmetric key K. That is, both the national cryptographic algorithm module 3 and the receiving terminal 4 store the SM1 symmetric encryption algorithm and the first symmetric key K. The gas data comprises a gas usage amount data M, a gas concentration, temperature, and more. When it is detected that the gas meter reading system based on the national cryptographic algorithm is in use, the information acquisition device 1 starts and collects the gas data. The information acquisition device 1 then sends the gas data collected to the central information processor 2.

S20, receiving and processing, by a central information processor 2, the gas data before generating a meter reading data.

In the present embodiment, the central information processor 2 receives the gas data sent by the information acquisition device 1, when the gas data comprises the gas concentration and temperature, a level corresponding to the gas concentration and temperature is determined, and it is decided if the gas concentration or temperature exceed the gas concentration threshold or the temperature threshold accordingly, if do, a warning signal accordingly will be sent to the controller 8, so that the controller 8 will control the buzzer 9 to alarm, thereby avoiding a risk in advance and improving a gas safety factor.

When the gas data comprises a gas usage amount data M, and more, the gas usage amount data will be analyzed and processed to obtain the meter reading data.

S30, encrypting the meter reading data to generate a first ciphertext, and encrypting a first digest of the first ciphertext to generate a first digest ciphertext by a national cryptographic algorithm module 3, before sending both the first ciphertext and the first digest ciphertext to a receiving terminal 4.

In the present embodiment, the national cryptographic algorithm module 3, after receiving the gas usage amount data M from the central information processor 2, uses a first symmetric key K preset to perform an SM1 encryption on the gas usage amount data M, and obtains a first ciphertext E_{K}(M), and then uses the SM3 digest algorithm to perform a digest calculation on the first ciphertext E_{K}(M) to obtain a first digest H (E_{K}(M)). Then the national cryptographic algorithm module 3 performs a bitwise inversion operation on the first symmetric key K to obtain a second symmetric key K′. For example, if an inverse code of a number 0 is set to 1, and an inverse code of a number 1 is set to 0, if the first symmetric key K is 11100011010, then the second symmetric key K′ is 00011100101. Therefore, preset the inverse code of each character in the first symmetric key K, so as to obtain the second symmetric key K′ according to a mapping relationship between the first symmetric key K and the inverse code thereof. Then, the national cryptographic algorithm module 3 uses the second symmetric key K′ to perform an SM1 encryption on the first digest H(E_{K}(M)) to obtain a first digest ciphertext E_{K′}(H(E_{K}(M))), and finally both the first ciphertext E_{K}(M) and the first digest ciphertext E_{K′}(H (E_{K}(M))) are together sent to the receiving terminal 4. In this way, a two-time SM1 encryption method to encrypt both the gas usage amount data and the digest is adopted, so that an information is not easily destroyed or stolen during a transmission process, thus a security is further improved.

Specifically, the national cryptographic algorithm module encrypts the meter reading data to generate the first ciphertext, and encrypts the first digest of the first ciphertext to generate a first digest ciphertext, before sending both the first ciphertext and the first digest ciphertext to the receiving terminal, comprising:

S31, acquiring the gas usage amount data by the national cryptographic algorithm module;

S32, using, by the national cryptographic algorithm module, the first symmetric key to perform an SM1 encryption onto the gas usage amount data, before obtaining the first ciphertext;

S33, adopting, by the national cryptographic algorithm module, an SM3 digest algorithm to perform a digest calculation on the first ciphertext, before obtaining the first digest;

S34, performing, by the national cryptographic algorithm module, an inversion operation on the first symmetric key, to obtain a second symmetric key;

S35, using, by the national cryptographic algorithm module, the second symmetric key to perform an SM1 encryption onto the first digest before obtaining the first digest ciphertext;

S36, sending, from the national encryption algorithm module, both the first ciphertext and the first digest ciphertext to the receiving terminal.

Of course, in some implementations, it is also able to adopt a one-time SM1 encryption method to improve the security of the information transmission, that is, the first symmetric key K is applied to performing an SM1 encryption on the gas usage amount data M and obtaining the first ciphertext E_{K}(M), then use the SM3 digest algorithm to perform a digest calculation on the first ciphertext E_{K}(M) again to obtain the first digest H(E_{K}(M)). Then, both the first ciphertext E_{K}(M) and the first digest H(E_{K}(M)) are sent to the receiving terminal 4 together.

S40, decrypting the first digest ciphertext to obtain the first digest, and recalculating a digest of the first ciphertext to obtain a second digest by the receiving terminal, and decrypting the first ciphertext to obtain the meter reading data after ensuring that the second digest matches with the first digest successfully.

In the present embodiment, the receiving terminal 4 presets an inverse code of each character of the first symmetric key. By using a mapping relationship between the first symmetric key K and an inverse code thereof, the first symmetric key K is bit-wise inverted to obtain the second symmetric key K′. The receiving terminal 4 receives the first ciphertext E_{K}(M) and the first digest ciphertext E_{K′}(H(E_{K}(M))), then uses the second symmetric key K′ to decrypt the first digest ciphertext E_{K′}(H(E_{K}(M))) to obtain the first digest H(E_{K}(M)), then the receiving terminal 4 uses an SM3 digest algorithm to recalculate the digest of the first ciphertext E_{K}(M) to obtain the second digest. Then the receiving terminal 4 compares whether the second digest is as same as the first digest. Compare whether each character string of the second digest and that of the first digest is a same one by one. When the receiving terminal 4 determines that the second digest is as same as the first digest, it indicates that the information transmitted is complete without any damages, then uses the first symmetric key K to decrypt the first ciphertext E_{K}(M), before obtaining the gas usage amount data M in the meter reading data.

Specifically, the receiving terminal decrypts the first digest ciphertext to obtain the first digest, and recalculates a digest of the first ciphertext to obtain a second digest, and after ensuring that the second digest matches with the first digest successfully, decrypts the first ciphertext to obtain the meter reading data, comprising:

S41, receiving, by the receiving terminal, the first ciphertext and the first digest ciphertext;

S42, performing, by the receiving terminal, an inversion operation on the first symmetric key, before obtaining the second symmetric key;

S43, using, by the receiving terminal, the second symmetric key to decrypt the first digest ciphertext to obtain the first digest;

S44, recalculating, by the receiving terminal, the digest of the first ciphertext before obtaining the second digest;

S45, using the first symmetric key to decrypt the first ciphertext when the second digest is as same as the first digest, then obtaining the meter reading data which comprises the gas usage amount data.

Of course, if the second digest has a character different from a character in the first digest, then the receiving terminal 4 determines that the second digest does not match the first digest, now the receiving terminal 4 feeds back a message of verification failure, and discards the first ciphertext.

In some implementations, for the one-time encrypted transmission mode, at the receiving terminal, only the receiving terminal holding the first symmetric key may decrypt the first ciphertext to obtain the gas usage amount data in the meter reading data. It is understandable that, if the receiving terminal does not have the first symmetric key stored, a failure message will be fed back and the first ciphertext will be discarded.

All above, the present disclosure provides a gas meter reading system based on a national cryptographic algorithm and a gas data transmission method thereof, the gas meter reading system based on the national cryptographic algorithm comprises: an information acquisition device, the information acquisition device is applied to collecting the gas data; a central information processor, the central information processor connects to the information acquisition device, applied to receiving and processing the gas data to generate a meter reading data; a national cryptographic algorithm module, the national cryptographic algorithm module connects to the central information processor, applied to encrypting the meter reading data to generate a first ciphertext, and encrypting a first digest of the first ciphertext to generate a first digest ciphertext, before sending the first ciphertext and the first digest ciphertext to a receiving terminal; the receiving terminal, connects to the national cryptographic algorithm module, applied to decrypting the first digest ciphertext to obtain the first digest, and recalculating a digest of the first ciphertext to obtain a second digest, after matching the second digest with the first digest successfully, decrypting the first ciphertext to obtain the meter reading data. The present disclosure adopts the national cryptographic algorithm to make a dual encryption process on a data information of a user, before sending out, ensuring a safety of a user information and reducing a risk of leakage. At a same time, a gas concentration detector and a temperature detector are added, being able to monitor and alarm the gas concentration and the temperature in a real time, to prevent an excessive concentration and temperature of a gas leakage, from causing a safety accident, thus a safety of a resident during using the gas is ensured and a safety performance of the system is improved.

Of course, those of ordinary skills in the present art can understand that all or part of the processes in the methods of the embodiments described above, can be implemented by a computer program to instruct a plurality of relevant hardware (including a processor, a controller, and more.), and the program may be stored in a computer-readable storage medium, the program, when being executed, may comprises a plurality of processes according to the embodiments on the method described above. Wherein the storage medium may be a memory, a magnetic disk, an optical disk, and more.

It should be understood that, the application of the present disclosure is not limited to the above examples listed. Ordinary technical personnel in this field can improve or change the applications according to the above descriptions, all of these improvements and transforms should belong to the scope of protection in the appended claims of the present disclosure.

1-10. (canceled)

11. A gas meter reading system based on a national cryptographic algorithm, comprising: an information acquisition device, a sending terminal, and a receiving terminal connecting in a sequence, the sending terminal has a central information processor and a national cryptographic algorithm module connected to the central information processor, wherein the central information processor is applied to receiving and processing a gas data to generate a meter reading data; the national cryptographic algorithm module is applied to encrypt the meter reading data to generate a first ciphertext, and encrypt a first digest of the first ciphertext to generate a first digest ciphertext, before sending the first ciphertext and the first digest ciphertext to the receiving terminal; and
the receiving terminal is applied to decrypt the first digest ciphertext to obtain the first digest, and recalculate a digest of the first ciphertext to obtain a second digest, after matching the second digest with the first digest successfully, decrypt the first ciphertext to obtain the meter reading data.

12. The gas meter reading system according to claim 11, further comprising:
a gas concentration detector, connecting to the information acquisition device, applied to detecting a gas concentration when the gas meter reading system is in use, so that the central information processor is able to determine a gas concentration level corresponding to the gas concentration, according to the gas concentration; and
a temperature detector, connecting to the information acquisition device and applied to detecting a temperature when the gas meter reading system is in use, so that the central information processor is able to determine a temperature level corresponding to the temperature according to the temperature.

13. The gas meter reading system according to claim 11, further comprising:
a controller, an input terminal of the controller connecting to the central information processor, and an output terminal of the controller connecting to a buzzer, applied to receiving a warning signal from the central information processor before controlling the buzzer to ring according to the warning signal.

14. The gas meter reading system according to claim 11, further comprising:
a display module, connecting to the central information processor and applied to displaying a data, the display module comprising an LCD display and a display driver interface, while the display driver interface is arranged on the LCD display.

15. The gas meter reading system according to claim 11, further comprising:
a wireless receiving module, connecting to the receiving terminal, being a super regenerative receiving circuit, and having an antenna.

16. A gas data transmission method based on a national cryptographic algorithm, comprising:
collecting a gas data by an information acquisition device;
receiving and processing, by a central information processor of a sending terminal, the gas data before generating a meter reading data;
encrypting the meter reading data to generate a first ciphertext, and encrypting a first digest of the first ciphertext to generate a first digest ciphertext by a national cryptographic algorithm module of the sending terminal, before sending both the first ciphertext and the first digest ciphertext to a receiving terminal;
decrypting the first digest ciphertext to obtain the first digest, and recalculating a digest of the first ciphertext to obtain a second digest by the receiving terminal, and decrypting the first ciphertext to obtain the meter reading data after ensuring that the second digest matches with the first digest successfully.

17. The gas data transmission method according to claim 16, further comprising:
feeding back a message of verification failure by the receiving terminal when it is ensured that the second digest does not match with the first digest, and discarding the first ciphertext.

18. The gas data transmission method according to claim 16, wherein before the collecting of a gas data by an information acquisition device, further comprising:
negotiating, between the national cryptographic algorithm module and the receiving terminal, in advance to adopt a same SM1 symmetric encryption mode for a transmission, and set a common first symmetric key.

19. The gas data transmission method according to claim 18, wherein the meter reading data comprises a gas usage amount data, the encrypting of the meter reading data to generate a first ciphertext, and encrypting a first digest of the first ciphertext to generate a first digest ciphertext by a national cryptographic algorithm module of the sending terminal, before sending both the first ciphertext and the first digest ciphertext to a receiving terminal, comprising:
acquiring the gas usage amount data by the national cryptographic algorithm module;
using, by the national cryptographic algorithm module, the first symmetric key to perform an SM1 encryption onto the gas usage amount data, before obtaining the first ciphertext;
adopting, by the national cryptographic algorithm module, an SM3 digest algorithm to perform a digest calculation on the first ciphertext, before obtaining the first digest;
performing, by the national cryptographic algorithm module, an inversion operation on the first symmetric key, to obtain a second symmetric key;
using, by the national cryptographic algorithm module, the second symmetric key to perform an SM1 encryption onto the first digest before obtaining the first digest ciphertext;
sending, from the national encryption algorithm module, both the first ciphertext and the first digest ciphertext to the receiving terminal.

20. The gas data transmission method according to claim 18, wherein the decrypting of the first digest ciphertext to obtain the first digest, and recalculating a digest of the first ciphertext to obtain a second digest by the receiving terminal, and decrypting the first ciphertext to obtain the meter reading data after ensuring that the second digest matches with the first digest successfully, comprising:
receiving, by the receiving terminal, the first ciphertext and the first digest ciphertext;
performing, by the receiving terminal, an inversion operation on the first symmetric key, before obtaining the second symmetric key;
using, by the receiving terminal, the second symmetric key to decrypt the first digest ciphertext to obtain the first digest;
recalculating, by the receiving terminal, the digest of the first ciphertext before obtaining the second digest;
using the first symmetric key to decrypt the first ciphertext when the second digest is as same as the first digest, then obtaining the meter reading data which comprises the gas usage amount data.
